(19) United States
(12) Patent Application Publication
(10) Pub. No.: US 2026/0129297 A1
(43) Pub. Date: May 7, 2026

(54) CAMERA MODULE

(71) Applicant: Luxvisions Innovation Technology Corp. Limited, Guangzhou City (CN)

(72) Inventors: Shang-Wei Tsai, Guangzhou City (CN); Kai-Chih Liang, Guangzhou City (CN)

(73) Assignee: Luxvisions Innovation Technology Corp. Limited, Guangzhou City (CN)

(21) Appl. No.: 19/375,864

(22) Filed: Oct. 31, 2025

(30) Foreign Application Priority Data
Nov. 5, 2024 (CN) 202411565940.5

(51) Int. Cl. H04N 23/68; G03B 5/00; G03B 30/00; H04N 23/51; H04N 23/54; H04N 23/55; H04N 23/57

(52) U.S. Cl. CPC H04N 23/687; G03B 5/00; H04N 23/51; H04N 23/54; H04N 23/55; G03B 30/00; G03B 2205/0084; H04N 23/57

(57) ABSTRACT

A camera module includes a flexible assembly, a photosensitive module, and a plurality of actuating assemblies. The flexible assembly includes an inner frame, an outer frame, and a plurality of sets of rib assemblies. Each rib assembly is coupled between the inner frame and the outer frame. A middle opening of the photosensitive module corresponding to the inner frame is on the inner frame. The plurality of actuating assemblies are located around the photosensitive module, electrically connected to the flexible assembly, and configured to drive the photosensitive module. Each actuating assembly includes a carrier board, a first electrical pad, and a coil. The carrier board is on the inner frame. The first electrical pad is on the carrier board and is electrically connected to the inner frame. The coil is on the carrier board and is electrically connected to one of the at least one first electrical pad.

### CROSS-REFERENCE TO RELATED APPLICATION

This non-provisional application claims priority under 35 U.S.C. § 119(a) to Patent Application No. 202411565940.5 filed in China on Nov. 5, 2024, the entire contents of which are hereby incorporated by reference.

### BACKGROUND

### Technical Field

The present disclosure relates to a camera module, and in particular, to a camera module capable of optical image compensation.

### Related Art

A camera module of a mobile phone is mainly composed of a lens, a voice coil motor (VCM), an image sensor (such as a complementary metal-oxide-semiconductor (CMOS) image sensor, CIS), and a substrate (such as a printed circuit board (PCB) or a flexible printed circuit (FPC)). The VCM may drive the lens or the image sensor through a force generated by the coil when the coil is energized, thereby achieving auto focus compensation. Common VCMs currently existing in the market include lens-shift VCMs and sensor-shift VCMs.

However, in the design of VCMs, VCM manufacturers usually first manufacture a coil and a coil holder separately, and then assemble them through micro mechanical processing, increasing assembly tolerances and complexity of the assembly process.

Furthermore, in the design of sensor-shift VCMs, a substrate for arranging an image sensor has a flexible structure to provide displacement of the image sensor driven by a VCM. Therefore, a problem regarding reliability frequently occurs in a drop test.

### SUMMARY

In view of the above problems, the present disclosure provides a camera module, to resolve existing problems of assembly tolerances, complex assembly processes, and/or low drop reliability.

In some embodiments, a camera module includes a flexible assembly, a photosensitive module, and a plurality of actuating assemblies. The flexible assembly includes an inner frame, an outer frame, and a plurality of sets of rib assemblies. Each rib assembly is coupled between the inner frame and the outer frame. A middle opening of the photosensitive module corresponding to the inner frame is on the inner frame. The plurality of actuating assemblies are located around the photosensitive module, electrically connected to the flexible assembly, and configured to drive the photosensitive module. Each actuating assembly includes a carrier board, at least one first electrical pad, and a coil. The carrier board is on the inner frame. The at least one first electrical pad is on the carrier board and is electrically connected to the inner frame. The coil is on the carrier board and is electrically connected to one of the at least one first electrical pad. The flexible assembly configured to provide a freedom of motion for the photosensitive module.

In some embodiments, the actuating assembly is a micro-electromechanical (MEMS) actuator.

In some embodiments, the photosensitive module includes a reinforcement member and a photosensitive element. The reinforcement member covers the middle opening of the inner frame and is coupled to the inner frame. The photosensitive element is located in the middle opening of the inner frame and is fixed to the reinforcement member.

In some embodiments, an optical axis of the photosensitive element extends through the middle opening of the inner frame. In some embodiments, at least one of the plurality of actuating assemblies includes at least one second electrical pad and at least one guide hole. The at least one second electrical pad is on the carrier board. The at least one guide hole extends through the carrier board. Each guide hole is coupled between one of the at least one first electrical pad and one of the at least one second electrical pad. The photosensitive element is connected to one of the at least one second electrical pad through wire bonding.

In some embodiments, the coil is electrically connected to one of the at least one second electrical pad.

In some embodiments, the photosensitive module is soldered to a first surface of the inner frame.

In some embodiments, the photosensitive module is soldered to the first surface of the inner frame, and each first electrical pad is soldered to the first surface of the inner frame.

In some embodiments, at least one of the plurality of actuating assemblies includes at least one guide hole extending through the carrier board. One end of each guide hole is coupled to one of the at least one first electrical pad, and the coil is electrically connected to an other end of the guide hole.

In some embodiments, the photosensitive module is soldered to the first surface of the inner frame, the plurality of actuating assemblies are on a second surface of the inner frame, and at least one of the at least one first electrical pad is connected to the second surface of the inner frame through wire bonding.

In some embodiments, each rib assembly includes a first rib portion and a second rib portion. The first rib portion extends in a first direction and is coupled to the outer frame. The second rib portion extends in a second direction and is coupled between the first rib portion and the inner frame. The first direction is perpendicular to the second direction.

In some embodiments, the outer frame has a plurality of corner blocks protruding toward inside, and each corner block is located at a corner of the outer frame. Each rib assembly includes an outer frame rib, at least one connection rib, and a frame-shaped rib. The outer frame rib extends in a first direction and is coupled between two adjacent corner blocks. The at least one connection rib extends in a second direction and is coupled between the inner frame and the outer frame rib, where the first direction is perpendicular to the second direction. Two opposite corners of the frame-shaped rib are respectively coupled to an adjacent corner block and a corner end of the inner frame.

In summary, according to the camera module provided in any embodiment of the present disclosure, a problem of assembly tolerances is avoided and an assembly process is simplified through the plurality of actuating assemblies including the carrier board, the at least one first electrical pad, and the coil. Moreover, the flexible assembly including the inner frame, the outer frame, and the plurality of sets of rib assemblies can provide a decoupling structure for movement on a plane perpendicular to the optical axis for sensor-shift optical image compensation. In addition, in some embodiments, the actuating assembly including the first and/or the second electrical pad and the guide hole can eliminate resistance generated from pure wire bonding or other metal wire connections, thereby reducing a possibility of affecting an optical image stabilization (OIS) action. Moreover, in some embodiments, an overall assembly height of the camera module may be reduced through an arrangement relationship among the flexible assembly, the photosensitive module, and the plurality of actuating assemblies.

### BRIEF DESCRIPTION OF THE DRAWINGS

FIG. 1 is a schematic top view of a camera module according to any embodiments.

FIG. 2 is a sectional view of the camera module along a section line II-II in FIG. 1.

FIG. 3 is a sectional view of a camera module according to some other embodiments.

FIG. 4 is a sectional view of a camera module according to some still other embodiments.

FIG. 5 is a schematic top view of a flexible assembly according to some embodiments.

FIG. 6 is a schematic top view of a flexible assembly according to some other embodiments.

FIG. 7 is a schematic appearance diagram of a camera module including a lens, a housing, and a magnet according to any embodiments.

FIG. 8 is a schematic top view of a sectional view of the camera module including the lens, the housing, and the magnet along a section line VIII-VIII in FIG. 7.

FIG. 9 is a schematic top view of a camera module including a magnet according to any embodiments.

### DETAILED DESCRIPTION

The present disclosure is described in detail below with reference to drawings and specific embodiments, which are not construed as a limitation on the present disclosure.

It is to be particularly noted that, the following terms “first” and “second” are merely used for description and should not be understood as indicating or implying relative importance.

A camera module 100 is suitable for a mobile device with a camera function. For example, the mobile device may be an electronic device such as a smart phone, a wearable device, a tablet computer, or a pad device.

Referring to FIG. 1 to FIG. 4, in some embodiments, the camera module 100 includes a flexible assembly 10, a photosensitive module 20, and a plurality of actuating assemblies 30.

The flexible assembly 10 includes an inner frame 11, an outer frame 12, and a plurality of sets of rib assemblies 13. The inner frame 11 and the outer frame 12 are connected through the plurality of sets of rib assemblies 13. In other words, each rib assembly 13 is coupled between the inner frame 11 and the outer frame 12. In some embodiments, the inner frame 11, the outer frame 12, and the plurality of sets of rib assemblies 13 may be integrally formed. In some other embodiments, the inner frame 11, the outer frame 12, and the plurality of sets of rib assemblies 13 may be independent elements separated from each other and connected to each other through assembly to form a flexible assembly 10. In some embodiments, the flexible assembly 10 may be a flexible substrate or a silicon substrate.

A middle opening of the photosensitive module 20 corresponding to the inner frame 11 is provided on the inner frame 11. The flexible assembly 10 is conductive, and the photosensitive module 20 is further electrically connected to the inner frame 11. Specifically, the inner frame 11, the outer frame 12, and one or more sets of rib assemblies 13 have conductive lines. In other words, the inner frame 11, the outer frame 12, and a few of the rib assemblies 13 are composed of conductive lines and insulating base materials. The photosensitive module 20 is coupled to the conductive line of the inner frame 11, and is electrically connected to a circuit wire of the outer frame 12 through the conductive line of the inner frame 11 and the conductive line on the rib assembly 13 in sequence, so that an electrical signal from a circuit outside the camera module 100 may be transmitted to the photosensitive module 20. In some embodiments, the photosensitive module 20 may be a complementary metal-oxide-semiconductor (CMOS) image sensor (CIS). In some embodiments, the photosensitive module 20 may be electrically connected to the inner frame 11 through flip chip packaging or a surface-mount technology (SMT).

The plurality of actuating assemblies 30 are located around the photosensitive module 20 and electrically connected to the flexible assembly 10. Each actuating assembly 30 includes a carrier board 31, at least one first electrical pad 32, and a coil 33. The carrier board 31 is arranged on the inner frame 11, and the first electrical pad 32 and the coil 33 are located on the carrier board 31. The first electrical pad 32 is electrically connected to the inner frame 11. Specifically, the first electrical pad 32 of each actuating assembly 30 is coupled to the conductive line of the inner frame 11, and is electrically connected to the circuit wire of the outer frame 12 through the conductive line of the inner frame 11 and the conductive line on the rib assembly 13 in sequence, so that the electrical signal from the circuit outside the camera module 100 may be transmitted to the actuating assembly 30. The coil 33 is electrically connected to one of the at least one first electrical pad 32. Specifically, the coil 33 is electrically connected to the first electrical pad 32 and then is coupled to the conductive line of the inner frame 11, and is electrically connected to the circuit wire of the outer frame 12 through the conductive line of the inner frame 11 and the conductive line on the rib assembly 13 in sequence, so that the electrical signal from the circuit outside the camera module 100 may be transmitted to the coil 33. When the coil 33 is in a magnetic field, a current passing through coil 33 cuts a magnetic line of force, thereby generating a force for adjusting positions of the inner frame 11 and the photosensitive module 20. The flexible assembly 10 is configured to provide a freedom of motion for the photosensitive module 20. In some embodiments, the actuating assembly 30 is a micro-electromechanical actuator (MEMS actuator).

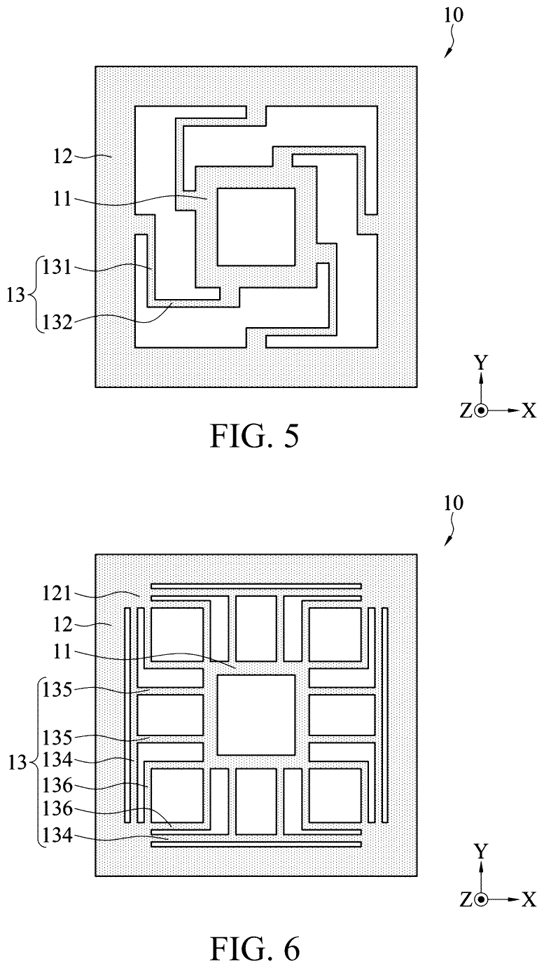

Referring to FIG. 5, in some embodiments, each rib assembly 13 includes a first rib portion 131 and a second rib portion 132. The first rib portion 131 extends in a first direction and is coupled to the outer frame 12. The second rib portion 132 extends in a second direction and is coupled between the first rib portion 131 and the inner frame 11. The first direction is perpendicular to the second direction. In some other implementations, four frame bars of the outer frame 12 each have a protrusion protruding inward, which is respectively coupled to one end of the first rib portion 131 of each rib assembly 13, an other end of each first rib portion 131 is respectively connected to one end of each second rib portion 132, and an other end of each second rib portion 132 is respectively coupled to a protrusion on each of four frame bars of the inner frame 11 protruding outward. Thus, the flexible assembly 10 has a function of decoupling in X and Y directions (i.e., freedom of displacement in the X and Y directions) through the connection of the first rib portion 131 and the second rib portion 132, and the plurality of sets of rib assemblies 13 have a freedom of rotation in a Z direction.

Referring to FIG. 6, in some embodiments, the outer frame 12 has a plurality of corner blocks 121 protruding toward inner, and each corner block 121 is located at a corner of the outer frame 12. Each rib assembly 13 includes an outer frame rib 134, at least one connection rib 135, and a frame-shaped rib 136. The outer frame rib 134 extends in a first direction and is coupled between two adjacent corner blocks 121. The at least one connection rib 135 extends in a second direction and is coupled between the inner frame 11 and the outer frame rib 134, where the first direction is perpendicular to the second direction. Two opposite corners of the frame-shaped ribs 136 are respectively coupled to an adjacent corner block 121 and a corner end of the inner frame 11. In an implementation, the outer frame 12 has four corner blocks 121 protruding toward inside at the four corners thereof. Each two corner blocks 121 are respectively connected by the outer frame rib 134. A middle section of each outer frame rib 134 is vertically coupled to two connection ribs 135 in a direction toward the inner frame 11. The four corner blocks 121 and four corner ends of the inner frame 11 are respectively coupled by the two opposite corners of the frame-shaped rib 136. Thus, the plurality of sets of rib assemblies 13 of the flexible assembly 10 provide a strong decoupling function in the X and Y directions, and the plurality of sets of rib assemblies 13 can provide transmission of electrical signals and data signals, have desirable flexibility in line layout, and can provide strong structural rigidity and a freedom of rotation in the Z direction.

In some embodiments, the photosensitive module 20 includes a photosensitive element 22. Specifically, one surface of the photosensitive element 22 has a photosensitive area 23, and the plane with the photosensitive area 23 is referred to as a photosensitive surface (the surface having the photosensitive area is referred to as a photosensitive surface below), and an other surface opposite to the photosensitive surface is a non-photosensitive surface. Based on this, the photosensitive surface includes the photosensitive area 23 and a non-photosensitive area (not shown in the figure).

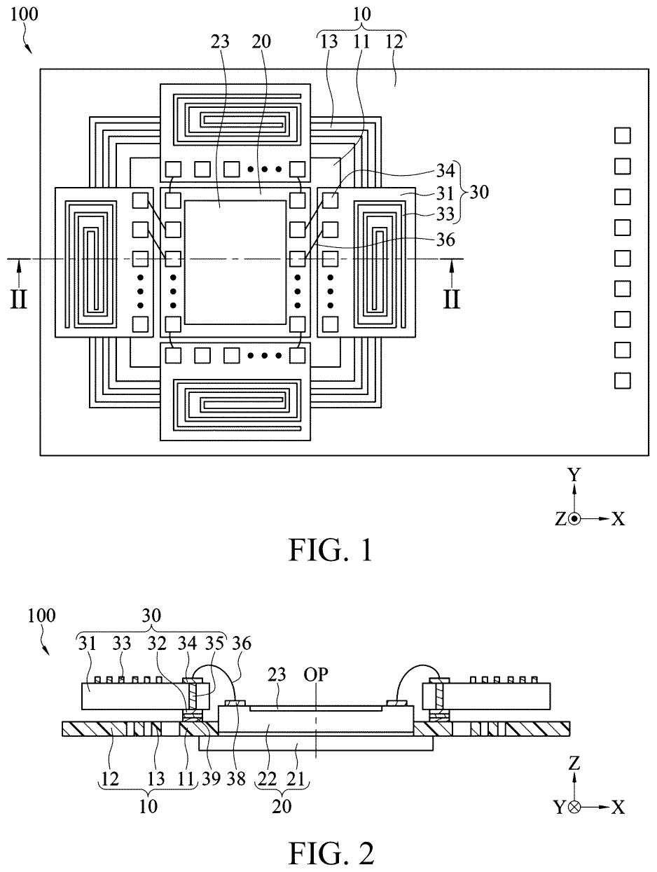

Referring to FIG. 2, in some embodiments, the photosensitive module 20 includes a reinforcement member 21 and a photosensitive element 22, and the photosensitive element 22 is fixed to the reinforcement member 21. The reinforcement member 21 covers the middle opening of the inner frame 11 and is coupled to the inner frame 11. For example, the inner frame 11 is arranged on the reinforcement member 21, and the photosensitive element 22 is located in the middle opening of the inner frame 11 and is fixedly arranged on the reinforcement member 21. In some embodiments, both the photosensitive element 22 and the inner frame 11 may be fixed to the reinforcement member 21 through an adhesive. In some embodiments, the reinforcement member 21 is a hard plate, for example, a metal plate such as a stainless steel plate. Thus, assembly flatness of the photosensitive module 20 may be maintained when the photosensitive element 22 is fixed to the reinforcement member 21.

In some embodiments, the photosensitive element 22 is arranged corresponding to the middle opening of the inner frame 11, and is located within the middle opening of the inner frame 11 (as shown in FIG. 2). One surface of the photosensitive element 22 is fixed to the reinforcement member 21, and the other surface having the photosensitive area 23 is a photosensitive surface. For example, the photosensitive element 22 is located within the middle opening of the inner frame 11 and arranged on the reinforcement member 21. Therefore, an optical axis OP emitted from the photosensitive surface of the photosensitive element 22 is located at the middle opening of the inner frame 11, and an extension line of the optical axis OP runs through the middle opening of the inner frame 11, as shown in FIG. 2.

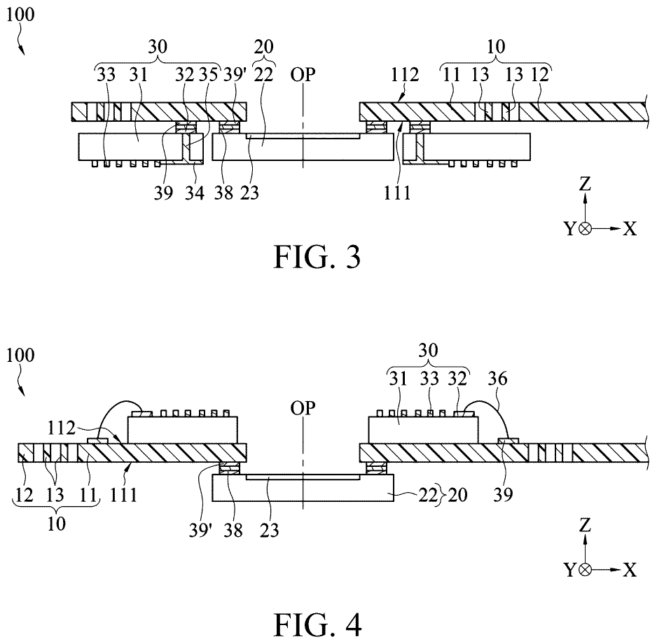

Referring to FIG. 3 and FIG. 4, in some embodiments, the photosensitive module 20 is the photosensitive element 22, and the photosensitive element 22 corresponds to the middle opening of the inner frame 11 and is soldered to a first surface 111 of the inner frame 11 with the photosensitive surface having the photosensitive area 23. Specifically, the photosensitive element 22 is arranged with the photosensitive area 23 being aligned with the middle opening of the inner frame 11 and is soldered to the first surface 111 of the inner frame 11 with the non-photosensitive area, so that the optical axis OP of the photosensitive element 22 runs through the middle opening of the inner frame 11. In other words, the photosensitive surface of the photosensitive element 22 having the photosensitive area 23 is parallel to and is not on the same plane as the middle opening of the inner frame 11. “The first surface 111 of the inner frame 11” is a plane of the inner frame 11 perpendicular to the optical axis, and an other plane opposite to “the first surface 111 of the inner frame 11” is “a second surface 112 of the inner frame 11”. Moreover, when the photosensitive element 22 is located on “the first surface 111 of the inner frame 11”, a distance between “the first surface 111 of the inner frame 11” and the photosensitive surface of the photosensitive element 22 is less than that of “the second surface 112 of the inner frame 11”. In other words, “the first surface 111 of the inner frame 11” connected to the photosensitive element 22 is adjacent to the photosensitive surface of the photosensitive element 22.

The photosensitive element 22 is configured to convert an optical image signal incident on the photosensitive module 20 into an electrical image signal. For example, when the camera module 100 is applied to a mobile device, the optical image signal is transmitted from outside of the mobile device and incident on the photosensitive element 22 of the photosensitive module 20 through lens assemblies such as lenses and optical sheets.

In some embodiments, at least one of the plurality of actuating assemblies 30 includes at least one second electrical pad 34 and at least one guide hole 35. The at least one second electrical pad 34 is located on the carrier board 31, and the at least one guide hole 35 extends through the carrier board 31. Each guide hole 35 is coupled between one of the at least one first electrical pad 32 and one of the at least one second electrical pad 34. The photosensitive element 22 is electrically connected to one of the at least one second electrical pad 34 by using a wire 36 through wire bonding. In some embodiments, the coil 33 is electrically connected to the one of the at least one second electrical pad 34. Specifically, the coil 33 may be electrically connected to the second electrical pad 34 directly, or may be electrically connected to second electrical pad 34 through the wire 36. After the coil 33 is electrically connected to the second electrical pad 34 on the carrier board 31, the coil is electrically connected to the first electrical pad 32 on an other end of the guide hole 35 through the guide hole 35 to which the coil is coupled, and then is electrically connected to the inner frame 11 through the first electrical pad 32.

In some other embodiments, at least one of the plurality of actuating assemblies 30 includes at least one guide hole 35 extending through the carrier board 31 and at least one first electrical pad 32 soldered to the first surface 111 of the inner frame 11. One end of guide hole 35 is coupled to one of the at least one first electrical pad 32, and an other end is electrically connected to the coil 33. For example, the coil 33 may be electrically connected to the first surface 111 of the inner frame 11 through the guide hole 35 and the first electrical pad 32. In some embodiments, the actuating assembly 30 further includes a second electrical pad 34 coupled to the other end of the guide hole 35 relative to the first electrical pad 32, so that the coil 33 may be electrically connected to the first surface 111 of the inner frame 11 through the second electrical pad 34, the guide hole 35, and the first electrical pad 32 in sequence.

In some still other embodiments, the plurality of actuating assemblies 30 are arranged on the second surface 112 of the inner frame 11, and at least one of the at least one first electrical pad 32 is connected to the second surface 112 of the inner frame 11 through wire bonding. For example, the actuating assembly 30 is directly fixed to the second surface 112 of the inner frame 11 through an adhesive, while the actuating assembly 30 is electrically connected to the inner frame 11 through the first electrical pad 32 and the wire 36.

The above first electrical pad 32 is an electrical pad located on the carrier board 31 and electrically connected to the inner frame 11, while the above second electrical pad 34 is an electrical pad on the carrier board 31 located at the other end of the guide hole 35 relative to the first electrical pad 32. For example, the first electrical pad 32 may be electrically connected to the first surface 111 or the second surface 112 of the inner frame 11, and the second electrical pad 34 may be electrically connected to the coil 33 or the photosensitive element 22.

It may be learned from the above that, through integration of the coil 33 and electrical connection elements (such as the electrical pad 32/34, the guide hole 35, and the wire 36) on the actuating assembly 30, resistance generated from electrical connection merely by using a wire bonding technology can be eliminated, thereby reducing impact on optical image stabilization.

In some embodiments, the non-photosensitive area on the photosensitive surface of the photosensitive element 22 has at least one third electrical pad 38. The third electrical pad 38 is an electrical pad located on the non-photosensitive area of the photosensitive element 22 and electrically connected to the inner frame 11.

In some embodiments, the inner frame 11 has at least one fourth electrical pad 39/39′, which may be electrically connected to the actuating assembly 30 or the photosensitive module 20. The fourth electrical pad 39/39′ is an electrical pad located on the inner frame 11.

For example, the actuating assembly 30 may be directly soldered to the fourth electrical pad 39 with the first electrical pad 32 through soldering tin, or may be connected to the fourth electrical pad 39 with the first electrical pad 32 by using the wire 36 through wire bonding, to achieve electrical connection between the actuating assembly 30 and the inner frame 11.

For example, the photosensitive module 20 may be directly soldered to the third electrical pad 38 and the fourth electrical pad 39′ through soldering tin, so that the photosensitive module 20 may be directly soldered to the inner frame 11. Alternatively, the photosensitive module 20 may be sequentially connected to the third electrical pad 38, the wire 36, the second electrical pad 34, the guide hole 35, the first electrical pad 32, and the fourth electrical pad 39, thereby achieving electrical connection between the photosensitive module 20 and the inner frame 11. In other words, the photosensitive module 20 may be electrically connected to the inner frame 11 through the wire 36, the guide hole 35, the electrical pad, or a combination thereof, or may be directly soldered to the inner frame 11.

In some embodiments, the guide hole 35 may be a through silicon via (TSV) wire or a through glass via (TGV) wire.

In some embodiments, the wire 36 may be a gold wire, a silver wire, or other metal wires, and may be electrically connected by using a wire bonding technology.

Referring to FIG. 1 and FIG. 2, in some implementations, the camera module 100 includes a flexible assembly 10, a photosensitive module 20, and four actuating assemblies 30. The flexible assembly 10 includes an inner frame 11, an outer frame 12, and a plurality of sets of rib assemblies 13. The photosensitive module 20 includes a photosensitive element 22 and a reinforcement member 21, and a plurality of third electrical pads 38 are located on the photosensitive surface of the photosensitive element 22. The reinforcement member 21 covers the middle opening of the inner frame 11, and both the inner frame 11 and the photosensitive element 22 are arranged on the reinforcement member 21 through an adhesive. The four actuating assemblies 30 are respectively located on four sides of the photosensitive module 20, and each actuating assembly 30 includes a carrier board 31, a plurality of first electrical pads 32, a plurality of second electrical pads 34, and a coil 33 arranged on the carrier board 31, and a plurality of guide holes 35 extending through the carrier board 31. Each carrier board 31 is soldered to the fourth electrical pad 39 on the inner frame 11 with the first electrical pads 32, and an other side thereof opposite the side electrically connected to the inner frame 11 has the coil 33 and the plurality of second electrical pads 34 arranged thereon. The coil 33 is connected to some of the second electrical pads 34 through a wire 36 (a connection status is not shown in the figure) or electrically connected to some of the second electrical pads 34 directly. The first electrical pads 32 and the second electrical pads 34 are respectively located on two ends of the guide hole 35 extending through the carrier board 31. The plurality of third electrical pads 38 are located on a non-photosensitive area surrounding the photosensitive area 23 of the photosensitive element 22, and the third electrical pads 38 are electrically connected to some of the second electrical pads 34 by using the wire 36 through the wire bonding technology. Based on this, the photosensitive element 22 is electrically connected to the conductive line of the inner frame 11 through the third electrical pads 38, the wire 36, the second electrical pads 34, the guide hole 35, the first electrical pads 32, and the fourth electrical pad 39 in sequence, and may transmit the electrical signal from the circuit outside the camera module 100 to the photosensitive module 20. The coil 33 is electrically connected to the conductive line of the inner frame 11 through the second electrical pads 34, the guide hole 35, the first electrical pads 32, and the fourth electrical pad 39 in sequence, and generates a force for driving the flexible assembly 10 when a current passing through the coil 33 cuts a magnetic line of force, thereby adjusting a position of the photosensitive module 20 to achieve movement flexibility.

Referring to FIG. 3, in some other implementations, the camera module 100 includes a flexible assembly 10, a photosensitive module 20, and four actuating assemblies 30. The photosensitive element 22 and the four actuating assemblies 30 are all located on the same side surface of the flexible assembly 10. The flexible assembly 10 includes an inner frame 11, an outer frame 12, and a plurality of sets of rib assemblies 13, and a surface of the inner frame 11 close to the photosensitive element 22 (i.e., the first surface 111) has a plurality of fourth electrical pads 39/39′ arranged thereon. The photosensitive module 20 is the photosensitive element 22, and the photosensitive element 22 has a photosensitive area 23 and a non-photosensitive area surrounding the photosensitive area 23. A plurality of third electrical pads 38 are arranged on the non-photosensitive area. The photosensitive area 23 of the photosensitive element 22 corresponds to the middle opening of the inner frame 11 and is soldered to the fourth electrical pads 39′ on the first surface 111 of the inner frame 11 with the plurality of third electrical pads 38 on the non-photosensitive area, so as to transmit the electrical signal from the circuit outside the camera module 100 to the photosensitive module 20. Four actuating assemblies 30 are respectively located on four sides of the photosensitive module 20, and each actuating assembly 30 includes a carrier board 31, a plurality of first electrical pads 32, a plurality of second electrical pads 34, and a coil 33 arranged on the carrier board 31, and a plurality of guide holes 35 extending through the carrier board 31. Some of the actuating assemblies 30 have a guide hole 35 extending through the carrier board 31, and the first electrical pads 32 and the second electrical pads 34 are respectively located on two ends of the guide hole 35. One surface of the actuating assembly 30 having the first electrical pads 32 is close to the inner frame 11, and an other surface has the coil 33 arranged thereon. The coil 33 is connected to the second electrical pads 34, and is electrically connected to the inner frame 11 through the guide hole 35, the first electrical pads 32, and the fourth electrical pads 39. Therefore, a force for driving the flexible assembly 10 when a current passing through the coil 33 cuts a magnetic line of force is generated, thereby adjusting a position of the photosensitive module 20 to achieve movement flexibility.

Referring to FIG. 4, in some still other implementations, the camera module 100 includes a flexible assembly 10, a photosensitive module 20, and four actuating assemblies 30. The photosensitive element 22 and the four actuating assemblies 30 are respectively located on different side surfaces of the flexible assembly 10. The flexible assembly 10 includes an inner frame 11, an outer frame 12, and a plurality of sets of rib assemblies 13, and a surface of the inner frame 11 close to the photosensitive element 22 (i.e., the first surface 111) has a plurality of fourth electrical pads 39′ arranged thereon. The photosensitive module 20 is the photosensitive element 22, and the photosensitive element 22 has a photosensitive area 23 and a non-photosensitive area surrounding the photosensitive area 23. A plurality of third electrical pads 38 are arranged on the non-photosensitive area. The photosensitive area 23 of the photosensitive element 22 corresponds to the middle opening of the inner frame 11 and is soldered to the fourth electrical pads 39′ on the first surface 111 of the inner frame 11 with the plurality of third electrical pads 38 on the non-photosensitive area, so as to transmit the electrical signal from the circuit outside the camera module 100 to the photosensitive module 20. Four sides located on the second surface 112 of the inner frame 11 (i.e., an other surface opposite to the first surface 111) and located on the middle opening of the inner frame 11 have four actuating assemblies 30 arranged thereon, and each actuating assembly 30 includes a carrier board 31, a plurality of first electrical pads 32 arranged on the carrier board 31, and a coil 33. The first electrical pads 32 and the coil 33 are located on the same plane of the carrier board 31, and an other plane of the carrier board 31 is fixed to the inner frame 11 through an adhesive. The coil 33 is connected to some of the first electrical pads 32, and is electrically connected to the inner frame 11 through the wire 36 and the fourth electrical pads 39. Therefore, a force for driving the flexible assembly 10 when a current passing through the coil 33 cuts a magnetic line of force is generated, thereby adjusting a position of the photosensitive module 20 to achieve movement flexibility.

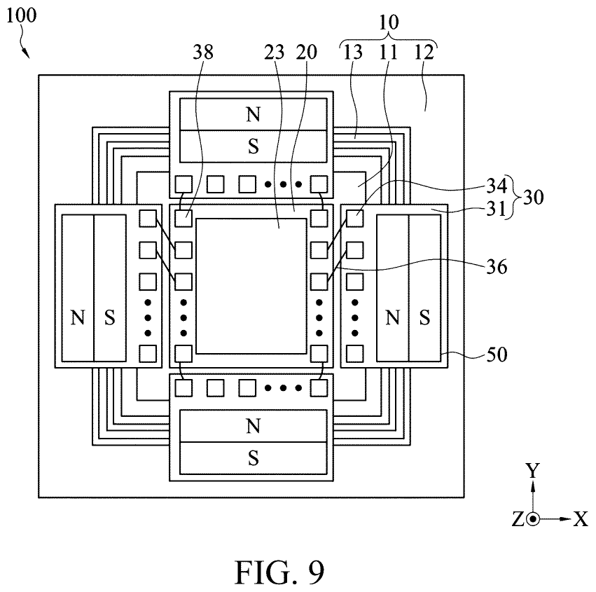

In some embodiments, although the above actuating assembly 30 is arranged on the inner frame 11, a surface thereof adjacent to the flexible assembly 10 is adjacent to an area where the inner frame 11, the plurality of sets of rib assemblies 13, and the outer frame 12 are located, as shown in FIG. 1 and FIG. 9.

Referring to FIG. 5, in some embodiments, each rib assembly 13 includes a first rib portion 131 and a second rib portion 132. The first rib portion 131 extends in a first direction and is coupled to the outer frame 12. The second rib portion 132 extends in a second direction and is coupled between the first rib portion 131 and the inner frame 11. The first direction is perpendicular to the second direction. In some implementations, four frame bars of the outer frame 12 each have a protrusion protruding inward, which is respectively coupled to one end of the first rib portion 131 of each rib assembly 13, an other end of each first rib portion 131 is respectively connected to one end of each second rib portion 132, and an other end of each second rib portion 132 is respectively coupled to a protrusion on each of four frame bars of the inner frame 11 protruding outward. Thus, the flexible assembly 10 has a function of decoupling in X and Y directions (i.e., freedom of displacement in the X and Y directions) through the connection of the first rib portion 131 and the second rib portion 132, and the plurality of sets of rib assemblies 13 have a freedom of rotation in a Z direction.

Referring to FIG. 6, in some embodiments, the outer frame 12 has a plurality of corner blocks 121 protruding toward inner, and each corner block 121 is located at a corner of the outer frame 12. Each rib assembly 13 includes an outer frame rib 134, at least one connection rib 135, and a frame-shaped rib 136. The outer frame rib 134 extends in a first direction and is coupled between two adjacent corner blocks 121. The at least one connection rib 135 extends in a second direction and is coupled between the inner frame 11 and the outer frame rib 134, where the first direction is perpendicular to the second direction. Two opposite corners of the frame-shaped ribs 136 are respectively coupled to an adjacent corner block 121 and a corner end of the inner frame 11. In some implementations, the outer frame 12 has four corner blocks 121 protruding toward inside at the four corners thereof. Each two corner blocks 121 are respectively connected by the outer frame rib 134. A middle section of each outer frame rib 134 is vertically coupled to two connection ribs 135 in a direction toward the inner frame 11. The four corner blocks 121 and four corner ends of the inner frame 11 are respectively coupled by the two opposite corners of the frame-shaped rib 136. Thus, the plurality of sets of rib assemblies 13 of the flexible assembly 10 provide a strong decoupling function in the X and Y directions (i.e., a freedom of displacement in the X and Y directions), and the plurality of sets of rib assemblies 13 can provide transmission of electrical signals and data signals, have desirable flexibility in line layout, and can provide strong structural rigidity and a freedom of rotation in the Z direction.

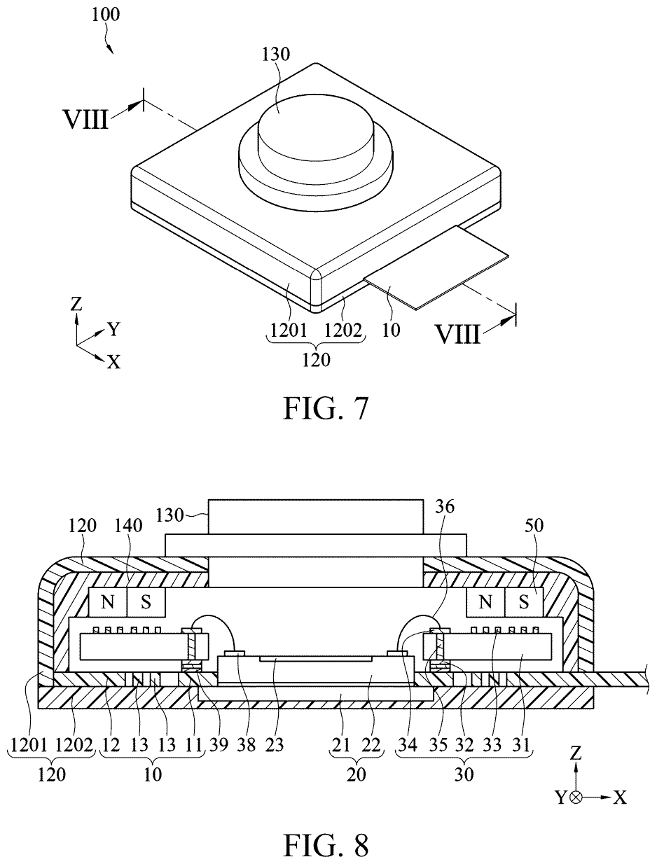

Referring to FIG. 7 and FIG. 8, the camera module 100 further includes a housing 120 and a lens 130. For example, the housing 120 includes an upper housing 1201 and a lower housing 1202, and the lens 130 is arranged on the upper housing 1201. The housing 120 has an accommodating space to accommodate the flexible assembly 10, the photosensitive module 20, and the plurality of actuating assemblies 30. In some embodiments, the outer frame 12 of the flexible assembly 10 is to be located outside the housing 120 for electrical connection to other electronic elements of the mobile device.

In some embodiments, the camera module 100 further includes an auto focus (AF) assembly (not shown) located between the lens 130 and the photosensitive module 20. A composition structure and an operation mode of the auto focus assembly are well-known in the art, and therefore are not described in detail herein.

In some embodiments, a plurality of sets of magnets 50 are respectively arranged above the plurality of actuating assemblies 30 and corresponding to the coil 33 (as shown in FIG. 8 and FIG. 9). The magnets 50 are respectively fixed on a support member 140, and the support member 140 is arranged on the outer frame 12 and is connected to the upper housing 1201 and the lens 130. Specifically, the plurality of magnets 50 may be embedded in the support member 140, so as to be adjacent to the coil 33 of the actuating assembly 30. A Lorentz force generated from coupling induction between a magnetic force of magnets 50 and coil 33 of actuating assembly 30 is an actuating force, which enables the flexible assembly 10 to guide movement of the photosensitive module 20.

Referring to FIG. 8 and FIG. 9, in some implementations, the camera module 100 includes a flexible assembly 10, a photosensitive module 20, four actuating assemblies 30, a plurality of magnets 50, a housing 120, a lens 130, and a support member 140. The lens 130 is arranged on the housing 120, and the flexible assembly 10, the photosensitive module 20, the plurality of actuating assemblies 30, the magnets 50, and the support member 140 are located inside the housing 120 (except that a part of the outer frame 12 of the flexible assembly 10 is located outside the housing 120). The housing includes an upper housing 1201 and a lower housing 1202. The flexible assembly 10 includes an inner frame 11, an outer frame 12, and a plurality of sets of rib assemblies 13, and is located on the lower housing 1202. The support member 140 is arranged on the outer frame 12 and is connected to the upper housing 1201 and the lens 130. Each magnet 50 is arranged on the support member 140 and is located between the upper housing 1201 and each actuating assembly 30. The photosensitive module 20 includes a photosensitive element 22 and a reinforcement member 21, and a plurality of third electrical pads 38 are located on the photosensitive surface of the photosensitive element 22. The reinforcement member 21 covers the middle opening of the inner frame 11 and is located on the lower housing 1202. The inner frame 11 and the photosensitive element 22 are both arranged on the reinforcement member 21 through an adhesive. The four actuating assemblies 30 are respectively located on four sides of the photosensitive module 20, and each actuating assembly 30 includes a carrier board 31, a plurality of first electrical pads 32, a plurality of second electrical pads 34, and a coil 33 arranged on the carrier board 31, and a plurality of guide holes 35 extending through the carrier board 31. Each carrier board 31 is soldered to the fourth electrical pad 39 on the inner frame 11 with the first electrical pads 32, and an other side thereof opposite the side electrically connected to the inner frame 11 has the coil 33 and the plurality of second electrical pads 34 arranged thereon. The coil 33 is electrically connected to some of the second electrical pads 34 and is adjacent to the magnets 50. The first electrical pads 32 and the second electrical pads 34 are respectively located on two ends of the guide hole 35 extending through the carrier board 31. The plurality of third electrical pads 38 are located on a non-photosensitive area surrounding the photosensitive area 23 of the photosensitive element 22, and the third electrical pads 38 are electrically connected to some of the second electrical pads 34 by using the wire 36 through the wire bonding technology. Based on this, the photosensitive element 22 is electrically connected to the conductive line of the inner frame 11 through the third electrical pads 38, the wire 36, the second electrical pads 34, the guide hole 35, the first electrical pads 32, and the fourth electrical pad 39 in sequence, and may transmit the electrical signal from the circuit outside the camera module 100 to the photosensitive module 20. The coil 33 is electrically connected to the conductive line of the inner frame 11 through the second electrical pads 34, the guide hole 35, the first electrical pads 32, and the fourth electrical pad 39 in sequence, and generates a force for driving the flexible assembly 10 when a current passing through the coil 33 cuts a magnetic line of force provided by the magnets 50, thereby adjusting a position of the photosensitive module 20 to achieve movement flexibility.

In summary, according to the camera module 100 provided in any embodiment of the present disclosure, a problem of assembly tolerances is avoided and an assembly process is simplified through a combination of the plurality of actuating assemblies 30 including the carrier board 31, the at least one first electrical pad 32, and the coil 33 (some of which further include the guide hole 35 and the wire 36) and the flexible assembly 10. Moreover, the flexible assembly 10 having the plurality of sets of rib assemblies 13 can provide more flexible planar displacement and overall structural rigidity. Moreover, in some embodiments, an overall assembly height may be reduced through an arrangement relationship among the flexible assembly 10, the photosensitive module 20, and the plurality of actuating assemblies 30.

Certainly, the present disclosure may have various other embodiments. Without departing from the spirit of the present disclosure and its essence, a person skilled in the art may make various corresponding changes and modifications according to the present disclosure, but these corresponding changes and modifications shall fall within the protection scope of the claims appended to the present disclosure.

What is claimed is:

1. A camera module, comprising:
a flexible assembly, comprising an inner frame, an outer frame, and a plurality of sets of rib assemblies, wherein each rib assembly is coupled between the inner frame and the outer frame;
a photosensitive module, wherein a middle opening of the photosensitive module corresponding to the inner frame is on the inner frame; and
a plurality of actuating assemblies, located around the photosensitive module, electrically connected to the flexible assembly, and configured to drive the photosensitive module, wherein each actuating assembly comprises:
a carrier board, on the inner frame;
at least one first electrical pad, on the carrier board and electrically connected to the inner frame; and
a coil, on the carrier board and electrically connected to one of the at least one first electrical pad;
wherein the flexible assembly is configured to provide a freedom of motion for the photosensitive module.

2. The camera module according to claim 1, wherein the actuating assembly is a micro-electromechanical (MEMS) actuator.

3. The camera module according to claim 1, wherein the photosensitive module comprises:
a reinforcement member, covering the middle opening of the inner frame and coupled to the inner frame; and
a photosensitive element, located in the middle opening of the inner frame and fixed to the reinforcement member.

4. The camera module according to claim 3, wherein at least one of the plurality of actuating assemblies comprises:
at least one second electrical pad, on the carrier board; and
at least one guide hole, extending through the carrier board, wherein each guide hole is coupled between one of the at least one first electrical pad and one of the at least one second electrical pad; and
the photosensitive element is connected to one of the at least one second electrical pad through wire bonding.

5. The camera module according to claim 3, wherein an optical axis of the photosensitive element extends through the middle opening of the inner frame.

6. The camera module according to claim 5, wherein at least one of the plurality of actuating assemblies comprises:
at least one second electrical pad, on the carrier board; and
at least one guide hole, extending through the carrier board, wherein each guide hole is coupled between one of the at least one first electrical pad and one of the at least one second electrical pad; and
the photosensitive element is connected to one of the at least one second electrical pad through wire bonding.

7. The camera module according to claim 6, wherein the coil is electrically connected to one of the at least one second electrical pad.

8. The camera module according to claim 1, wherein the photosensitive module is welded to a first surface of the inner frame.

9. The camera module according to claim 8, wherein each first electrical pad is welded to the first surface of the inner frame.

10. The camera module according to claim 8, wherein at least one of the plurality of actuating assemblies comprises:
at least one guide hole, extending through the carrier board, wherein one end of each guide hole is coupled to one of the at least one first electrical pad, and the coil is electrically connected to an other end of the guide hole.

11. The camera module according to claim 8, wherein the plurality of actuating assemblies are on a second surface of the inner frame, and at least one of the at least one first electrical pad is connected to the second surface of the inner frame through wire bonding.

12. The camera module according to claim 1, wherein
each rib assembly comprises:
a first rib portion, extending in a first direction and coupled to the outer frame; and
a second rib portion, extending in a second direction and coupled between the first rib portion and the inner frame, wherein the first direction is perpendicular to the second direction.

13. The camera module according to claim 1, wherein
the outer frame has a plurality of corner blocks protruding toward inside, and each corner block is located at a corner of the outer frame; and
each rib assembly comprises:
an outer frame rib, extending in a first direction and coupled between two adjacent corner blocks;
at least one connection rib, extending in a second direction and coupled between the inner frame and the outer frame rib, wherein the first direction is perpendicular to the second direction; and
a frame-shaped rib, wherein two opposite corners of the frame-shaped rib are respectively coupled to an adjacent corner block and a corner end of the inner frame.
